(19) United States
(12) Patent Application Publication
(10) Pub. No.: US 2021/0025233 A1
(43) Pub. Date: Jan. 28, 2021

(54) CEILING TILE LADDER ATTACHMENT DEVICE

(71) Applicants: Jackie West, East Moline, IL (US); Nancy West, East Moline, IL (US)

(72) Inventors: Jackie West, East Moline, IL (US); Nancy West, East Moline, IL (US)

(21) Appl. No.: 16/900,325

(22) Filed: Jun. 12, 2020

Related U.S. Application Data
(60) Provisional application No. 62/877,650, filed on Jul. 23, 2019.

(51) Int. Cl. E06C 7/14

(52) U.S. Cl. CPC E06C 7/146

(57) ABSTRACT

The ceiling tile ladder attachment device holds ceiling tiles while a user is working on a ladder to install or replace the tiles in the ceiling, in addition to storing tiles that have to be removed from the ceiling and held for re-installation after performing other maintenance above the tiles. The ceiling tile ladder attachment device includes a rectangular wire rack that attaches to the back side of a ladder. The wire rack has a hook part on the back side. The hook part preferably attaches to the wire rack in two places to prevent the wire rack from swinging or slipping on the ladder. The hook part includes adjustable hook points for different styles and size of step ladders. The user can attach the ceiling tile ladder attachment device to the backside of the ladder using the hook part.

### CROSS-REFERENCE TO RELATED APPLICATION

The present application is related to and claims priority from prior provisional application Ser. No. 62/877,650, filed Jul. 23, 2019, the entire application of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of ladder attachments. More specifically, the invention is ceiling tile holder that is easily attachable to a wide variety and sizes of ladders and safely holds a number of ceiling tiles so that they can be installed quickly and without damage.

### 2. Description of the Related Art

The ceiling is an important aspect contributing to the aesthetic appeal of a room. Installing ceiling tiles is a common way of improving the aesthetics of a ceiling, and thereby the entire room. When a ceiling tile breaks, or is otherwise damaged by water, insects, etc., it is usually easier to replace the ceiling tile rather than attempt a repair. Often, multiple ceiling tiles need replaced, but can only be installed one at a time. This requires the worker to climb up and down the ladder to retrieve and place each tile, or attempt to balance the tiles on the top of the ladder, where they may easily be knocked off and broken. A more efficient and reliable way is needed.

Ideally, a ceiling tile ladder attachment device should provide a secure place to store a group of ceiling tiles on the ladder while attaching to a wide range of ladder types and sizes, yet would operate reliably and be manufactured at a modest expense. Thus, a need exists for a reliable ceiling tile ladder attachment device to avoid the above-mentioned problems.

### BRIEF SUMMARY OF THE INVENTION

In view of the foregoing disadvantages inherent in the known ladder attachment art, the present invention provides a novel ceiling tile ladder attachment device. The general purpose of the present invention, which will be described subsequently in greater detail, is to provide a secure place to store a group of ceiling tiles on a ladder where they can easily be reached by a person at the top of the ladder for installation.

The present invention relates to ladder attachments. More particularly, the present invention relates to a ceiling tile ladder attachment device. The ceiling tile ladder attachment device provides the user with an easy-to-install rack that conveniently hooks on to the backside of a ladder and holds approximately 8-10 ceiling tiles. The hooks are adjustable to accommodate different style and size ladders.

The ceiling tile ladder attachment device allows ceiling tiles to be installed with equally efficiency and convenience to the installer at home, hospitals, schools, office buildings, or anywhere else. Having the ceiling tiles in the basket saves the user time as the user is no longer required to climb up and down a ladder to retrieve ceiling tiles or risk knocking them off the top of the ladder and breaking them before they are even installed.

The present invention holds significant improvements and serves as a ceiling tile ladder attachment device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention that are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures that accompany the written portion of this specification illustrate embodiments and method(s) of use for the present invention, a ceiling tile ladder attachment device, constructed and operative according to the teachings of the present invention.

FIG. 1 shows a back perspective view illustrating a ceiling tile ladder attachment device according to an embodiment of the present invention.

FIG. 2 is a front perspective view illustrating a ceiling tile ladder attachment device according to an embodiment of the present invention of FIG. 1.

FIG. 3 is a side perspective view illustrating a ceiling tile ladder attachment device according to an embodiment of the present invention of FIG. 1.

FIG. 4 is a side perspective view illustrating a ceiling tile ladder attachment device attached to a ladder according to an embodiment of the present invention of FIG. 1.

FIG. 5 is a front perspective view illustrating a ceiling tile ladder attachment device attached to a ladder according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a ladder attachment. More specifically, the invention is ceiling tile holder that is easily attachable to a wide variety and sizes of ladders and safely holds a number of ceiling tiles so that they can be installed quickly and without damage.

Generally speaking, the presently claimed invention will hold ceiling tiles while a user is working on a ladder to install or replace the tiles in the ceiling, in addition to storing tiles that have to be removed from the ceiling and held for re-installation after performing other maintenance above the tiles.

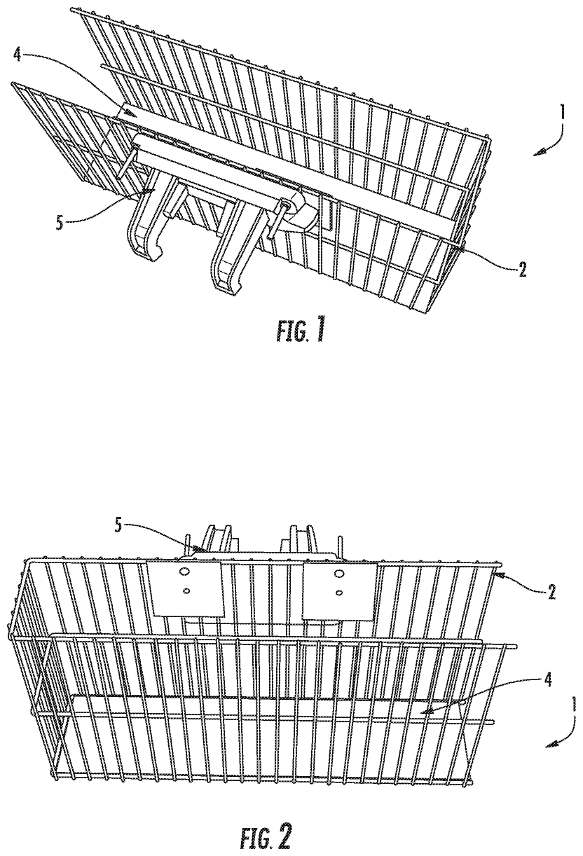

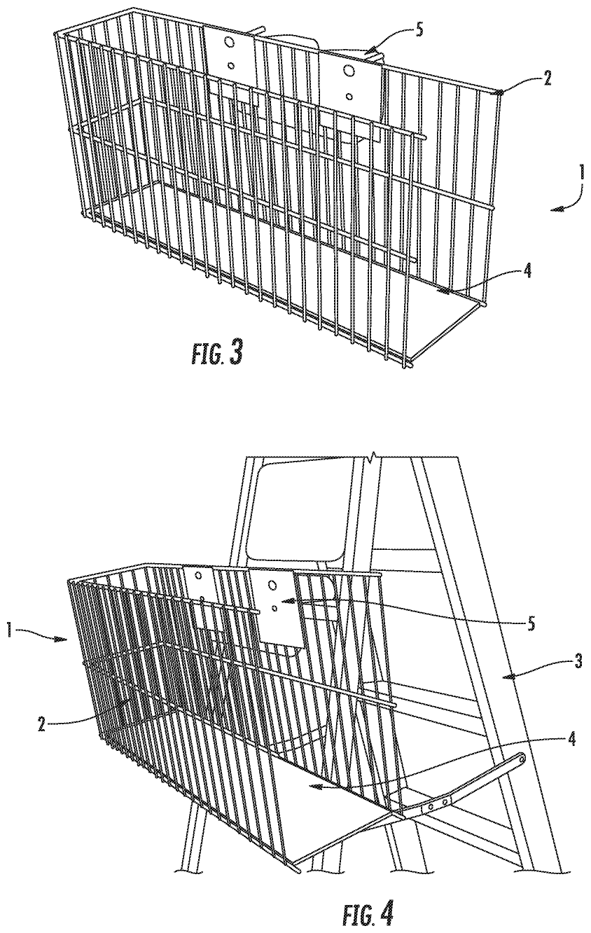

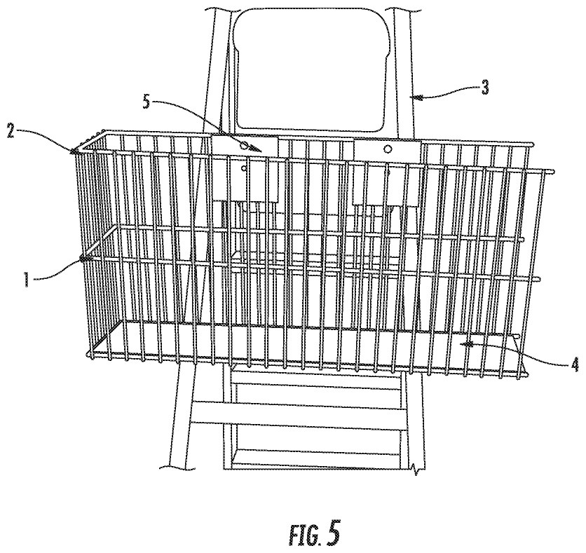

As shown in FIGS. 1-5, the ceiling tile ladder attachment device 1 includes a rectangular wire rack 2 that attaches to the back side of a ladder 3. The wire rack 2 can be any suitable dimensions, but is preferably wide enough to hold up to six tiles 4. The tiles 4 may be entirely within the wire basket 2, or may extend out the open top of the wire basket 2. The wire rack 2 also preferably is is two feet long. The wire rack 2 is preferably made of metal and may have a plastic or rubber coating.

The wire rack 2 has a hook part 5 on the back side. The hook part 5 preferably attaches to the wire rack in two places to prevent the wire rack 2 from swinging or slipping on the ladder 3. The hook part 5 includes adjustable hook points for different styles and size of step ladders 3. The user can attach the ceiling tile ladder attachment device 1 to the backside of the ladder 3 using the hook part 5.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ceiling tile ladder attachment device comprising:
(a) a wire rack body; and
(b) a hook part having
(i) a backing part;
(ii) two adjustable hooks operably located opposite each other on either side of the backing part; and
(iii) two attachment parts,
wherein the hook part is operably attached to the wire rack body via the two attachment parts so that the hook part is parallel to a top of the wire rack body in order to prevent the wire rack body from rotating or slipping when attached to a ladder, and
wherein the two adjustable hooks are adjustable to fit a variety of ladder run sizes and shapes.

2. The ceiling tile ladder attachment device according to claim 1, wherein the wire rack body further comprises:
(i) two length pieces;
(ii) one side piece; and
(iii) one base piece.

3. The ceiling tile ladder attachment device according to claim 1, wherein the wire rack body has a length of two feet.

3. The ceiling tile ladder attachment device according to claim 1, wherein the wire rack body comprises a metal.

4. The ceiling tile ladder attachment device according to claim 1, wherein the wire rack body comprises a metal coated in a plastic or rubber material.

5. A ceiling tile ladder attachment device comprising:
(a) a metal wire rack body having
(i) two length pieces;
(ii) a side piece; and
(iii) a base piece,
wherein the wire rack body has a length of two feet; and
(b) a hook part having
(i) a backing part;
(ii) two adjustable hooks operably located opposite each other on either side of the backing part; and
(iii) two attachment parts,
wherein the hook part is operably attached to the wire rack body via the two attachment parts so that the hook part is parallel to a top of the wire rack body in order to prevent the wire rack body from rotating or slipping when attached to a ladder, and
wherein the two adjustable hooks are adjustable to fit a variety of ladder run sizes and shapes.

6. The ceiling tile ladder attachment device according to claim 1, wherein the metal wire rack body further comprises a plastic or rubber material coating.
